(19) United States
(12) Patent Application Publication
(10) Pub. No.: US 2014/0029137 A1
(43) Pub. Date: Jan. 30, 2014

(54) MAGNETIC RECORDING MEDIUM AND MAGNETIC RECORDING/REPRODUCTION APPARATUS USING THE SAME

(71) Applicant: KABUSHIKI KAISHA TOSHIBA, Tokyo (JP)

(72) Inventors: Takayuki MUSASHI, Chigasaki-shi (JP); Hiroyuki HYODO, Yokohama-shi (JP)

(73) Assignee: KABUSHIKI KAISHA TOSHIBA, Tokyo (JP)

(21) Appl. No.: 13/710,275

(22) Filed: Dec. 10, 2012

(30) Foreign Application Priority Data
Jul. 25, 2012 (JP) 2012-164621

(51) Int. Cl. G11B 5/725

(52) U.S. Cl. CPC G11B 5/725
USPC 360/99.08; 428/833; 428/833.3

(57) ABSTRACT

According to one embodiment, letting (Rf) be main-chain portion C₂F₄O contained in a Fomblin lubricant and a compound containing a phosphazene ring and (R) be terminal group (CF₃—C₆H₄—O—)₅(NP)₅—O—CH₂CF₂ contained in the compound containing a phosphazene ring in a magnetic recording medium, the ratio, which is measured using TOF-SIMS, of the component of (R) to the component of (Rf) on the surface of a lubricant layer is 0.01 to 0.09%.

### CROSS-REFERENCE TO RELATED APPLICATIONS

This application is based upon and claims the benefit of priority from Japanese Patent Application No. 2012-164621, filed Jul. 25, 2012, the entire contents of which are incorporated herein by reference.

### FIELD

Embodiments described herein relate generally to a magnetic recording medium and a magnetic recording/reproduction apparatus using the same.

### BACKGROUND

Time-of-flight secondary ion mass spectrometry (TOF-SIMS) is a surface analysis method of irradiating the surface of a sample with a pulsed ion beam and detecting generated secondary ions by using a time-of-flight mass spectrometer. It is possible to analyze a lubricating film on the surface of a magnetic recording medium by using this method, thereby checking, for example, the film thickness, the uniformity, the molecular weight distribution, the terminal structure, an additive, and the properties of the chemical bond to the substrate.

For example, there is a method by which the detection ratio of a predetermined component contained in a phosphazene-based compound of an additive component of a lubricating film to a main-chain portion of a main component of the lubricating film measured by TOF-SIMS is set at a defined ratio, thereby ensuring the reliability of a magnetic recording medium and preventing aggregation after the lubricating layer is applied. When using a lubricating film containing a phosphazene-based compound, however, even if the detection ratio is set at the defined ratio, the compound containing a phosphazene ring may cause an error such as the adhesion of a lubricant to a magnetic head. This sometimes makes it impossible to satisfy the reliability of a magnetic recording/reproduction apparatus.

### BRIEF DESCRIPTION OF THE DRAWINGS

FIG. 1 is an exemplary view showing an example of the arrangement of a magnetic recording medium according to an embodiment;

FIG. 2 is a partially exploded perspective view showing a magnetic recording/reproduction apparatus to which the magnetic recording medium according to the embodiment is applicable;

FIG. 3 is a graph showing examples of the detected value of (Rf); and

FIG. 4 is a graph showing examples of the detected value of (R).

### DETAILED DESCRIPTION

In general, according to one embodiment, a magnetic recording medium includes a substrate, a magnetic recording layer, a magnetic recording layer, a protective layer, a lubricant layer.

The embodiment will be explained below with reference to the accompanying drawings.

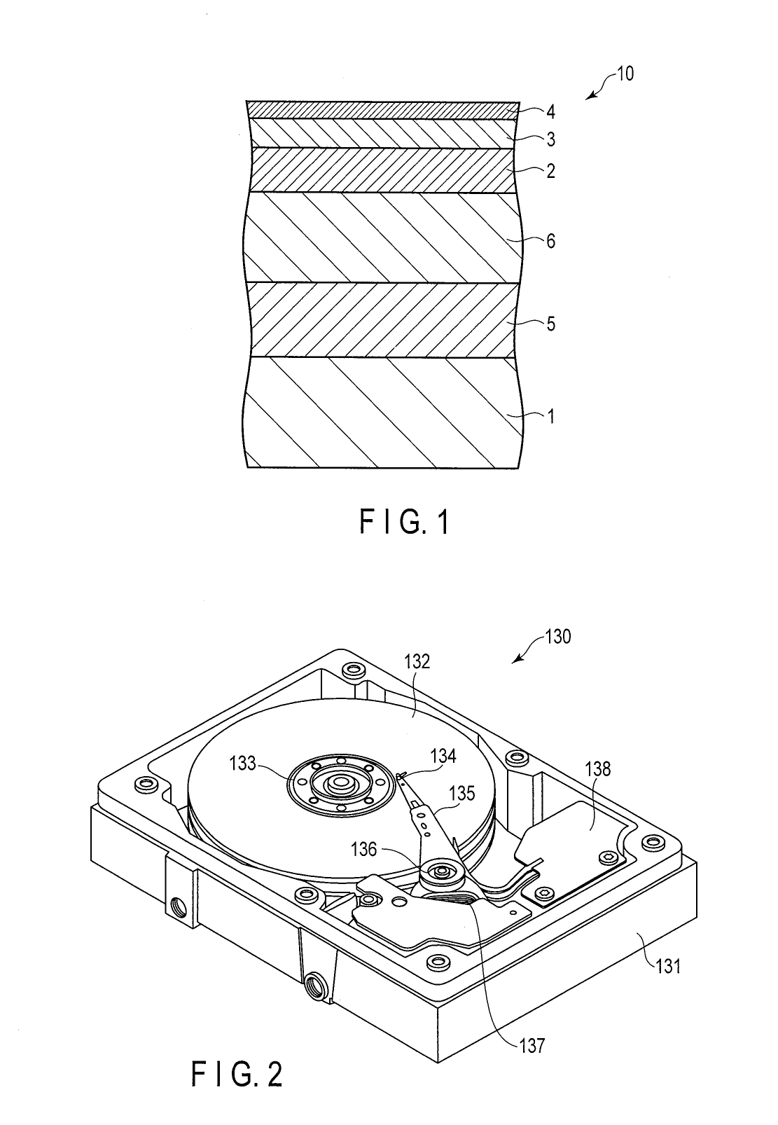

FIG. 1 is an exemplary view for explaining the sectional structure of a magnetic recording medium according to the embodiment.

As shown in FIG. 1, a magnetic recording medium 10 includes a substrate 1, an SUL layer 5 formed on the substrate 1, an interlayer 6 formed on the SUL layer 5, a magnetic recording layer 2 formed on the interlayer 6, a protective layer 3 formed on the magnetic recording layer 2, and a lubricant layer 4 formed on the protective layer 3.

The lubricant layer 4 contains a lubricant component and additive component.

The lubricant component used in the embodiment contains a Fomblin main chain represented by

—(CF₂CF₂O)ₘ—(CF₂O)ₙ— (1)

wherein each of m and n is an integer of 1 or more, and a Fomblin lubricant having a tetraol terminal group represented by

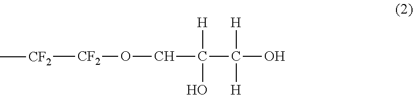

Also, the additive component used in the embodiment is a compound containing a phosphazene ring represented by

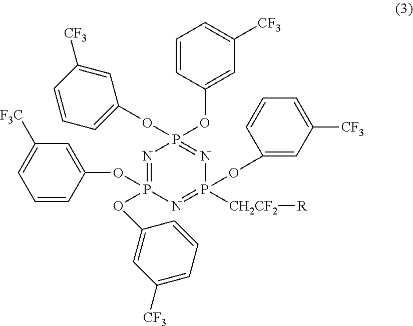

In the above formula (3), R represents perfluoropolyether containing polar terminal group.

Furthermore, in the magnetic recording medium 10 according to the embodiment, letting (Rf) be main-chain portion C₂F₄O contained in the Fomblin lubricant and the compound containing a phosphazene ring, and (R) be terminal group (CF₃—C₆H₄—O—)₅(NP)₅—O—CH₂CF₂ contained in the compound containing a phosphazene ring, the ratio of the component of (R) to the component of (Rf) on the surface of the lubricant layer measured by using time-of-flight secondary ion mass spectrometry is 0.01 to 0.09%.

According to the embodiment, when the (R)/(Rf) ratio is 0.01 to 0.09%, a magnetic head error caused by the adhesion of the lubricant hardly occurs when magnetic recording and reproduction are performed on the magnetic recording medium 10.

As the substrate 1, it is possible to use, for example, a glass substrate, an Al-based alloy substrate, a ceramic substrate, a carbon substrate, or an Si single-crystal substrate having an oxidized surface.

As the magnetic recording layer 2, it is possible to use, for example, Co, Cr, Pt, Pd, Rh, B, Ta, Mo, Cu, Nd, W, Nb, Sm, Tb, Ru, or Re.

The material of the SUL layer 5 can be selected from, for example, Co, Ni, Fe, Ti, Ta, W, Cr, Pt, alloys containing these elements, and oxides and nitrides of these elements.

The interlayer 6 has two functions, i.e., the function of blocking the exchange coupling interaction between the SUL layer and recording layer, and the function of controlling the crystallinity of the recording layer. The material of the interlayer 6 can be selected from, for example, Ru, Pt, Pd, W, Ti, Ta, Cr, Si, alloys containing these elements, and oxides and nitrides of these elements.

Note that at least one of the SUL layer 5 and interlayer 6 can be omitted as needed.

A material containing carbon can be used as the protective layer 3. An example of a material usable as carbon is diamond-like carbon. The thickness of the protective layer 3 can be 1.5 to 2.4 nm from the viewpoints of the electromagnetic conversion characteristic and durability. If the thickness is less than 1.5 nm, the reliability often becomes insufficient from the viewpoints of the corrosion resistance and durability of the magnetic recording layer. If the thickness exceeds 2.4 nm, the recording capacity often becomes insufficient from the viewpoint of the electromagnetic conversion characteristic.

In the embodiment, Fomblin® Z-Tetraol manufactured by Solvay can be used as the lubricant. The lubricant layer 4 can have a thickness of 0.9 to 1.6 nm. If the thickness of the lubricant layer 4 is less than 0.9 nm, the reliability often becomes insufficient from the viewpoints of the durability and magnetic head floating stability. If the thickness exceeds 1.6 nm, the recording capacity often becomes insufficient from the viewpoint of the electromagnetic conversion characteristic.

FIG. 2 is a partially exploded perspective view showing an example of a magnetic recording/reproduction apparatus to which the magnetic recording medium according to the embodiment is applicable.

As shown in FIG. 2, a magnetic recording/reproduction apparatus 130 includes a rectangular box-like housing 131 having an open upper end, and a top cover (not shown) that is fastened to the housing 131 by using a plurality of screws and closes the open upper end of the housing.

The housing 131 houses, for example, a magnetic recording medium 132 according to the embodiment, a spindle motor 133 as a driving means for supporting and rotating the magnetic recording medium 132, a magnetic head 134 for performing recording and reproduction of magnetic signals with respect to the magnetic recording medium 132, a head actuator 135 that includes a suspension having a distal end portion on which the magnetic head 134 is mounted, and supports the magnetic head 134 so that the magnetic head 134 can freely move with respect to the magnetic recording medium 132, a rotating shaft 136 for rotatably supporting the head actuator 135, a voice coil motor 137 for rotating and positioning the head actuator 135 via the rotating shaft 136, and a head amplifier circuit board 138.

### EXAMPLES

Seven samples of disk-like magnetic recording media each manufactured by forming a 10- to 40-nm thick underlayer made of, for example, Ti, W, Cr, or Ru, an interlayer, a 10- to 40-nm thick magnetic layer as a magnetic recording layer made of, for example, Co, Pt, or Cr, and a 2.0-nm thick protective layer made of carbon on a nonmagnetic substrate were prepared.

The inner circumference of each magnetic recording medium was held by a jig, the medium was dipped in a tank containing a lubricant coating solution and held in it for a few minutes, and the jig holding the medium was pulled up from the tank, thereby coating the surface of the protective layer of the magnetic recording medium with a lubricant layer about 1.5 nm thick. Tables 1 and 2 (to be presented later) show the thicknesses of the lubricant layers of these samples.

The lubricant coating solutions used were as follows.

Tables 1 and 2 also show the lubricant coating solutions used for the samples.

Lubricant coating solution 1 was prepared by diluting, with 100 parts by weight of Vertrel® as a fluorine-based solvent available from Du Pont, solution prepared by mixing 25 parts by weight of Fomblin® Z-Tetraol and 25 parts by weight of a compound containing a phosphazene ring represented by formula (3) at a weight ratio of about a few tens of percent.

Lubricant coating solution 2 was prepared by diluting, with 100 parts by weight of a solvent (Vertrel), a solution prepared by mixing 25 parts by weight of Fomblin® Z-Tetraol and 25 parts by weight of the compound containing a phosphazene ring represented by formula (3) at a weight ratio of about ten-odd percent.

Lubricant coating solution 3 was prepared by diluting, with 100 parts by weight of a solvent (Vertrel), a solution prepared by mixing 25 parts by weight of Fomblin® Z-Tetraol and 25 parts by weight of the compound containing a phosphazene ring represented by formula (3) at a weight ratio of about a few percent.

Lubricant coating solution 4 was prepared by using only Fomblin® Z-Tetraol without using the compound containing a phosphazene ring.

After that, post-processes were performed under the following three different conditions combining baking and UV processing, thereby forming arbitrary lubricating states.

In post-process 1, baking was performed at 100 to 150° C. for a few minutes.

In post-process 2, baking was performed at 100 to 150° C. for a few minutes, and then UV processing was performed for a few seconds.

In post-process 3, baking was performed at 100 to 150° C. for a few minutes, and then UV processing was performed for ten-odd seconds.

Tables 1 and 2 show the lubricating layer thicknesses, lubricant coating solutions, and post-processes of the seven samples.

The lubricating layer surface of each obtained sample was measured using time-of-flight secondary ion mass spectrometry.

Letting (Rf) be main-chain portion C₂F₄O contained in the Fomblin lubricant and the compound containing a phosphazene ring, and (R) be terminal group (CF₃—C₆H₄—O—)₅(NP)₅—O—CH₂CF₂ contained in the compound containing a phosphazene ring, the ratio of the component of (R) to the component of (Rf) on the lubricant layer surface was obtained as the detection ratio of the embodiment, and whether this ratio was 0.01 to 0.09% as a percentage was checked. Tables 1 and 2 show the obtained results.

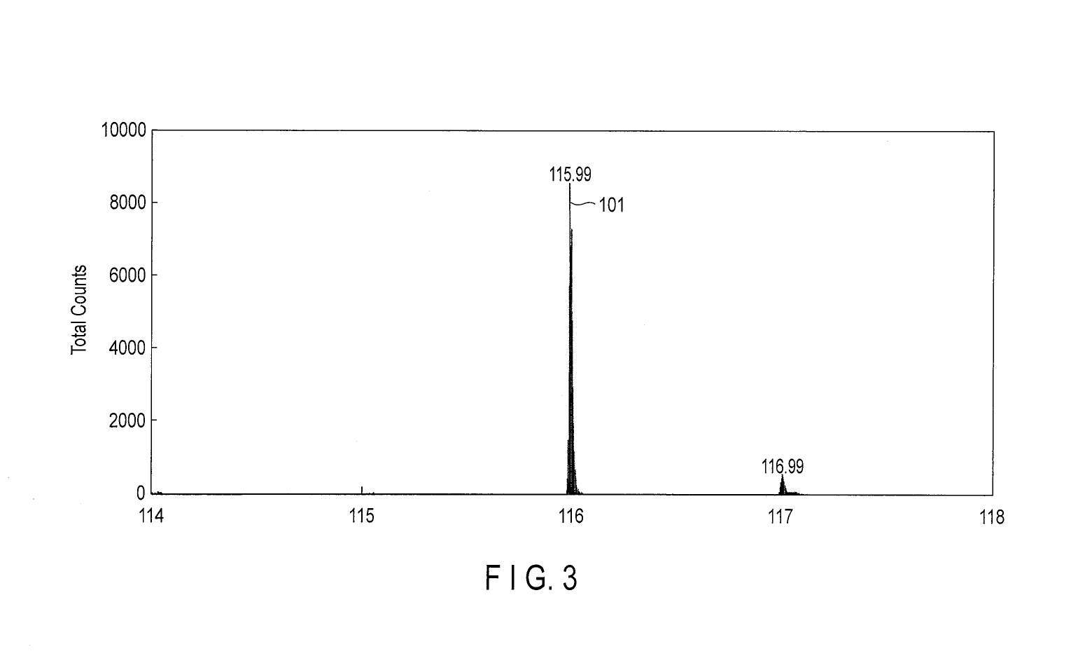

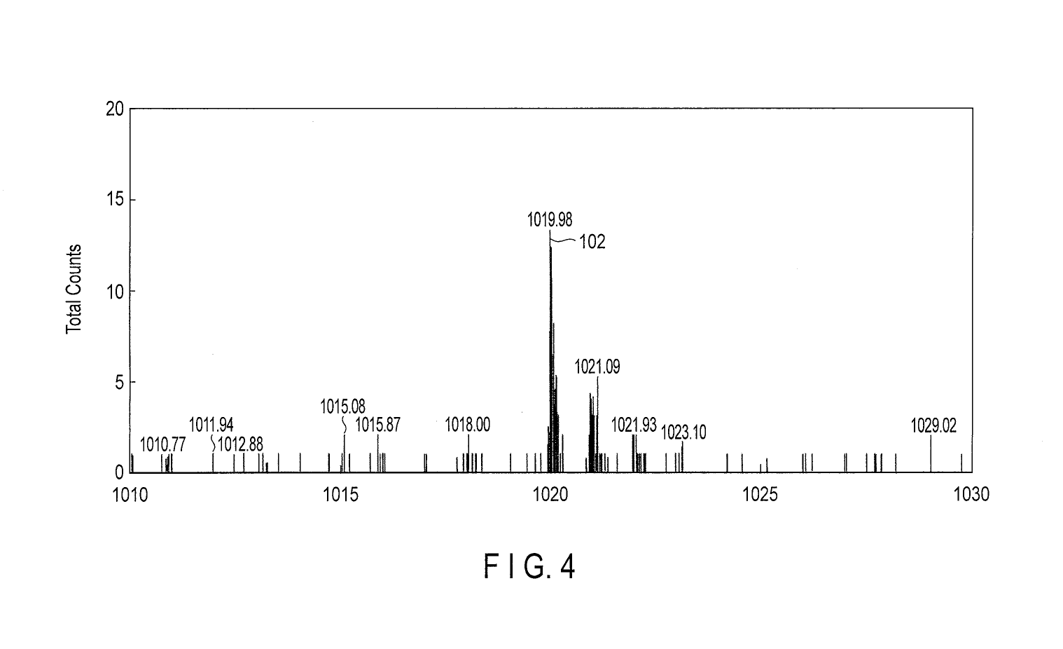

Also, FIGS. 3 and 4 are graphs showing examples of the detected values of (R) and (Rf).

As shown in FIGS. 3 and 4, a detection peak 101 of (Rf) was found near 116 amu, and a detection peak 102 of (R) was found near 1,020 amu.

In addition, letting (Rf′) be C₃F₅O₂ and (R′) be C₇F₃H₄O, the percentage of the (R′)/(Rf′) detection ratio was obtained as a detection ratio for comparison, from the above-described results obtained by measuring the lubricant layer surfaces by using time-of-flight secondary ion mass spectrometry. Table 1 shows the obtained results.

Note that the detection peak of (R′) was found near 163 amu, and that of (Rf′) was found near 161 amu, i.e., these peak positions were different from those of the detection peaks of (Rf) and (R).

### Pickup Test Results

Tables 1 and 2 also show the pickup test results of the samples.

In the pickup test, the amount of change in electromagnetic conversion characteristic caused by the adhesion of the lubricant was measured before and after a magnetic head was sought for a few hours at a disk rotational speed of 5,400 rpm. The result was regarded as OK if the electromagnetic conversion characteristic value remained unchanged, and NG if the value changed. Tables 1 and 2 show the obtained results.

### Measurement of Bond Ratio

The bond ratio was measured by rinsing each sample by dipping it in Vertrel as a solvent, and calculating the percentage (residual film thickness ratio) of the lubricating film thickness before and after the dipping.

### Durability Test

The durability test was conducted by floating a magnetic head in the presence of particles for a few hours at a disk rotational speed of 5,400 rpm. The result was regarded as OK if the electromagnetic conversion characteristic was not affected, and NG if it was affected. The state in which the particles were present was obtained by thermally spraying Al₂O₃ (alumina) powder on the disk. In this test, the result was NG only when using no phosphazene compound. This indicates that a phosphazene compound must be added in order to ensure the reliability of the magnetic recording medium.

Table 1 below shows the obtained results.

TABLE 1

| | Lubricant | Lubricant | | | Comparative | Detection | | |
|---|---|---|---|---|---|---|---|---|
| | layer thickness | coating | Post- | Bond ratio | detection | ratio of | Pickup | Durability |
| | (nm) | solution | process | (%) | ratio (%) | embodiment (%) | test result | test result |
| Sample 1 | 1.54 | 1 | 1 | 81.2 | 42.21 | 0.17 | NG | OK |
| Sample 2 | 1.55 | 1 | 2 | 81 | 28.50 | 0.07 | OK | OK |
| Sample 3 | 1.48 | 2 | 1 | 79.8 | 32.86 | 0.11 | NG | OK |
| Sample 4 | 1.51 | 2 | 2 | 79.8 | 37.83 | 0.09 | OK | OK |
| Sample 5 | 1.49 | 2 | 3 | 80.2 | 27.99 | 0.07 | OK | OK |

TABLE 2

| | Lubricant | | | Detection | | |
|---|---|---|---|---|---|---|
| | layer thickness | Lubricant | Post- | ratio of | Pickup | Durability |
| | (nm) | coating solution | process | embodiment (%) | test result | test result |
| Sample 6 | 1.55 | 4 | 1 | 0.00 | OK | NG |
| Sample 7 | 1.57 | 3 | 1 | 0.01 | OK | OK |

Of samples 1 to 5 as shown in Table 1, both the pickup test and durability test were OK for samples 2, 4, and 5 in which the detection ratio according to the embodiment deriving from phosphazene/main chain and detected by TOF-SIMS was 0.09 or less, and the durability test was OK but the pickup test was NG for samples 1 and 3 in which the detection ratio according to the embodiment exceeded 0.09. By contrast, the lubricant layer thickness, the bond ratio, and the comparative detection ratio deriving from phosphazene/main chain different from the embodiment in samples 1 to 5 did not change in relation to the results of the pickup test and durability test, so it was impossible to predict the results of the pickup test and durability test by only measuring these physical property values. This demonstrates that it is effective to check the detection ratio according to the embodiment in order to secure the reliability of the magnetic recording medium.

Table 2 shows the results of sample 6 formed as an example using a lubricant coating solution not containing the compound having a phosphazene ring, and sample 7 formed as a sample containing only a small amount (R/Rf≈0.01) of the compound having a phosphazene ring. As shown in Table 2, the durability decreased when using the lubricant coating solution not containing the compound having a phosphazene ring.

Also, sample 7 indicates that the durability increased when even a small amount of the compound having a phosphazene ring was contained.

As described above, when using the magnetic recording medium according to the embodiment, the reliability improves and the durability increases from the viewpoint of lubricant pickup.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium comprising:
a substrate;
a magnetic recording layer formed on the substrate;
a protective layer formed on the magnetic recording layer; and
a lubricant layer formed on the protective layer, and containing
a lubricant component containing a main chain represented by
—(CF₂CF₂O)ₘ—(CF₂O)ₙ— (1)
(wherein each of m and n is an integer of not less than 1)
and a tetraol terminal group represented by 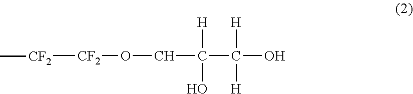
and an additive component containing a compound containing a phosphazene ring represented by 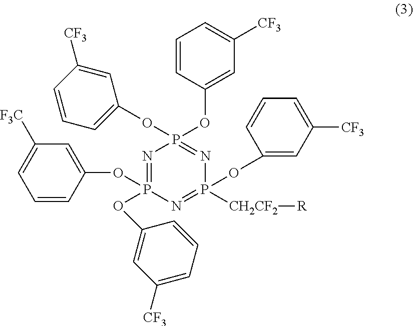
(wherein R represents perfluoropolyether containing polar terminal group),
wherein a ratio, which is measured by time-of-flight secondary ion mass spectrometry, of a component of side-chain portion (CF₃—C₆H₄—O—)₅(NP)₅—O—CH₂CF₂ (R) contained in the compound containing a phosphazene ring to a component of main-chain portion C₂F₄O (Rf) contained in the lubricant and the compound is 0.01 to 0.09% on the surface of the lubricant layer.

2. The medium according to claim 1, wherein the protective layer is formed by using carbon.

3. The medium according to claim 1, wherein the protective layer has a thickness of 1.5 to 2.4 nm.

4. The medium according to claim 2, wherein the protective layer has a thickness of 1.5 to 2.4 nm.

5. The medium according to claim 1, wherein the lubricant layer has a thickness of 0.9 to 1.6 nm.

6. The medium according to claim 2, wherein the lubricant layer has a thickness of 0.9 to 1.6 nm.

7. The medium according to claim 3, wherein the lubricant layer has a thickness of 0.9 to 1.6 nm.

8. The medium according to claim 4, wherein the lubricant layer has a thickness of 0.9 to 1.6 nm.

9. A magnetic recording/reproduction apparatus comprising:
a magnetic recording medium comprising
a substrate,
a magnetic recording layer formed on the substrate,
a protective layer formed on the magnetic recording layer, and
a lubricant layer formed on the protective layer, and containing
a lubricant component containing a main chain represented by
—(CF₂CF₂O)ₘ—(CF₂O)ₙ— (1)
(wherein each of m and n is an integer of not less than 1) and
a tetraol terminal group represented by 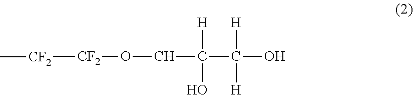
and an additive component containing a compound containing a phosphazene ring represented by 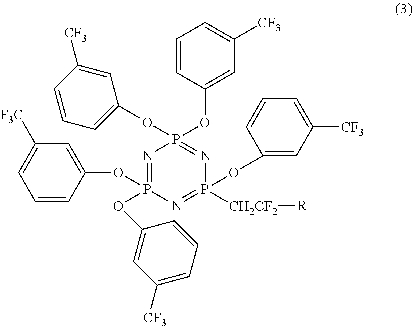
(wherein R represents perfluoropolyether containing polar terminal group);
a mechanism configured to support and rotate the magnetic recording medium; and
a magnetic head including an element for recording information on the magnetic recording medium and an element for reproducing recorded information,
wherein a ratio, which is measured by time-of-flight secondary ion mass spectrometry, of a component of side-chain portion (CF₃—C₆H₄—O—)₅(NP)₅—O—CH₂CF₂ (R) contained in the compound containing a phosphazene ring to a component of main-chain portion C₂F₄O (Rf) contained in the lubricant and the compound being 0.01 to 0.09% on the surface of the lubricant layer.

10. The apparatus according to claim 9, wherein the protective layer is formed by using carbon.

11. The apparatus according to claim 9, wherein the protective layer has a thickness of 1.5 to 2.4 nm.

12. The apparatus according to claim 10, wherein the protective layer has a thickness of 1.5 to 2.4 nm.

13. The apparatus according to claim 9, wherein the lubricant layer has a thickness of 0.9 to 1.6 nm.

14. The apparatus according to claim 10, wherein the lubricant layer has a thickness of 0.9 to 1.6 nm.

15. The apparatus according to claim 11, wherein the lubricant layer has a thickness of 0.9 to 1.6 nm.

16. The apparatus according to claim 12, wherein the lubricant layer has a thickness of 0.9 to 1.6 nm.
